(19) United States
(12) Patent Application Publication
(10) Pub. No.: US 2002/0089318 A1
(43) Pub. Date: Jul. 11, 2002

(54) System and method for performing power control using battery safety protection

(75) Inventors: Gene L. Armstrong II, Richardson, TX (US); Mike K. Mitchell, Frisco, TX (US)

Correspondence Address: Roger L. Maxwell, Jenkens & Gilchrist, P.C., Suite 3200, 1445 Ross Avenue, Dallas, TX, 75202-2799, US

(73) Assignee: Dallas Semiconductor Corporation

(21) Appl. No.: 09/755,658

(22) Filed: Jan. 5, 2001

(51) Int. Cl. G05F 1/40

(52) U.S. Cl. 323/285

(57) ABSTRACT

A system and methods for controlling power flow between a first and a second power supplies and an appliance. A first switch is coupled to the first power supply for switching power flow between the first power supply and the appliance. A second switch is coupled to the second power supply for switching power flow between the second power supply and the appliance. A first controller circuit is coupled to the first switch and the first power supply for monitoring at least one parameter of the first power supply and actuating the first switch to cease power flow if the at least one monitored parameter exceeds a given value, or deviates from a range of values. A second controller circuit is coupled to the first controller circuit, the second switch, and the second power supply for monitoring at least one parameter of the second power supply and actuating the second switch to cease power flow if the at least one monitored parameter exceeds a give value, or deviates from a given range. Each controller can be signaled to actuate its respective switch regardless of the monitored parameter. Additionally, one controller can be signaled to actuate its respective switch regardless of the monitored parameter, and then signal the other controller, or controllers if more than two exist, to actuate their respective switches.

### FIELD OF THE INVENTION

This invention relates to electronic devices, and more particularly to electronic devices for the control of rechargeable batteries, such as those that prevent damage caused to a rechargeable battery pack due to operating conditions that might be outside its design parameters and further to a device for switching power from the battery pack or between multiple battery packs. It further is directed to a power saving arrangement for rechargeable battery packs.

### BACKGROUND OF THE INVENTION

Many portable electronic systems, such as laptop computers, personal gaming machines, and cellular phones, are powered by rechargeable batteries. Such battery packs have the advantage that they are portable, relatively weight efficient, and can be charged and discharged many times.

As can be appreciated, it is very desirable to be able to accurately determine the remaining operating life of a rechargeable battery pack. This enables a user to get maximum use of the battery pack. Also, the battery packs must be protected from conditions which may be outside the designed operating range and which may cause damage to the rechargeable cells.

Conventional battery packs have incorporated a battery protection system to protect the pack from operating conditions outside its safe limits. For instance, protection systems may be present to prevent damage to a battery pack when the terminals are shorted by interrupting the current flow from the cells to the terminal. Some systems also protect from over currents and over voltages when the battery is charging, and under voltages when the battery is discharging, also by interrupting the current flow from the cells to the terminal. Interrupting the current flow is usually performed by a switching device incorporated into the battery pack itself. Protection from under voltage is needed in that in some battery chemistries an over discharge of a rechargeable battery may destroy or damage the battery.

Capacity gauging is generally performed by a battery controller within the battery powered device. It measures parameters of the battery pack and calculates the remaining capacity of in the pack or multiple packs. In addition to gauging the remaining charge capacity of a battery pack, the controller may also turn the device on or off. In some systems, a user operated switch sends a signal to the controller to change the power state of the device from an on power state to an off power state. Rather than gating current flow out of the pack, the operating circuitry of the device is just shut off. The controller must continually monitor the switch for an instruction to change power states regardless of whether the device is on or off. When the switch is off, power from the battery flows into the device, but cannot flow into the operating circuitry. When the switch is on, the device is powered. Thus, failing a condition that would operate the protection circuitry, the battery is always on and the device is switched internally. In a device utilizing multiple battery packs the controller has a selector which is used in selecting which of the multiple packs provides power to the device.

If the controller must continually monitor the user operated switch, it is a power drain on the battery both when the device is operating and when switched to off power state. Thus, when the battery pack is connected to the device, it is always draining current. Also, having a switch incorporated both into the pack for safety monitoring and the controller for changing power states is redundant. Eliminating either the switch for battery protection or the switching in the controller would decrease the impedance losses from the redundant switches and make the combination of the battery packs and device less expensive to manufacture.

### SUMMARY OF THE INVENTION

The present invention is drawn to a system and methods for controlling power flow between a first and a second power supplies and an appliance. A first switch is coupled to the first power supply for switching power flow between the first power supply and the appliance. A second switch is coupled to the second power supply for switching power flow between the second power supply and the appliance. A first controller circuit is coupled to the first switch and the first power supply for monitoring at least one parameter of the first power supply and actuating the first switch to cease power flow if the at least one monitored parameter exceeds a given value, or deviates from a range of values. A second controller circuit is coupled to the first controller circuit, the second switch, and the second power supply for monitoring at least one parameter of the second power supply and actuating the second switch to cease power flow if the at least one monitored parameter exceeds a give value, or deviates from a given range. Upon receiving a signal the first controller circuit provides a signal to the second controller circuit, and the second controller circuit actuates the second switch to allow power flow between the second power supply and the appliance. The first controller circuit actuates the first switch to cease power flow between the first power supply and the appliance. Upon receiving a second signal, the first controller circuit actuates the first switch to cease power flow between the power supply and the appliance without signaling the second controller circuit. The first controller circuit comprises a current monitor for measuring current flow from the first power supply. The system further comprises a current accumulator for accumulating values representative of the amount of current having flowed out of the first power supply, or the net amount of current having flowed into and out of the first power supply. The first controller circuit comprises a voltage monitor for monitoring a voltage of the first power supply. The system further comprises a register for storing at least one value representative of the at least one monitored parameter. The system is used in a portable electronic device. The first power supply is rechargeable.

### BRIEF DESCRIPTION OF THE DRAWINGS

A more complete understanding of the present invention may be had by reference to the following Detailed Description when taken in conjunction with the accompanying drawings wherein:

FIG. 1 is a schematic of a preferred application of the battery controller of this invention to a battery pack;

FIG. 1A is a detail of a battery controller of this invention depicting a configuration having an internal sense resistor;

FIG. 2 is a schematic of the battery controller of this invention;

FIG. 3 is a preferred register table of the battery controller of this invention;

FIG. 4 is a schematic of a exemplary circuit within the controller of this invention for monitoring the PS pin;

FIG. 5 is a schematic of an exemplary configuration for multiple battery packs and multiple controllers for automated selection of the pack with the highest voltage; and

FIG. 6 is a schematic of a preferred application of multiple battery packs and multiple battery controllers of this invention to a single appliance.

### DETAILED DESCRIPTION

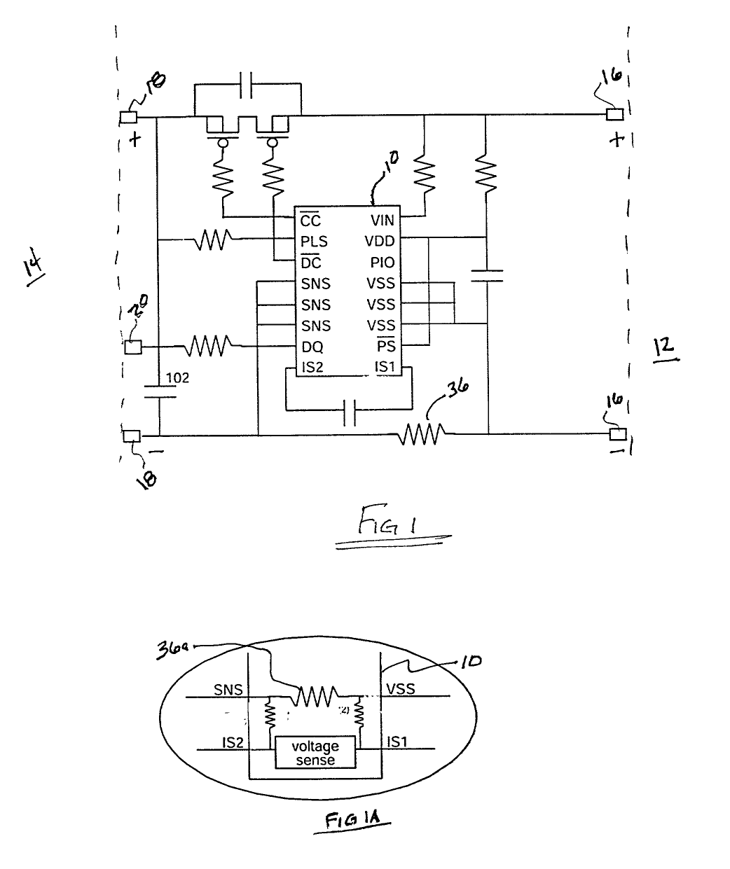

Referring now to the drawings where in like or similar elements are designated with identical reference numerals throughout the several views, and wherein the various elements depicted are not necessarily drawn to scale. In particular, referring to FIG. 1 there is illustrated a schematic depicting battery controller 10 connected between a battery 12 and an appliance 14. Battery 12 is a rechargeable power source, having, for example, a battery cell or multiple bundled battery cells, for storing electrical power and capable of supplying the stored power to appliance 14. Appliance 14 may be any device which draws some or all of its power from battery 12, for example, a portable personal computer, cellular telephone, or personal gaming device. Also, appliance 14 may be a charging device such as a stand-alone charger or a charger integral with another device. One skilled in the art will readily appreciate the applicability of battery controller 10 of this invention to many other appliances 14, and that the above examples are not exhaustive. Appliance 14 may utilize a single battery 12 made up of one or multiple cells (FIG. 1) or multiple batteries 12 each made up of one or multiple cells (FIG. 6). In either case, it is preferred, though not required, that each battery 12 have a controller 10. Though for safety reasons, it is preferred that if a battery does not have a controller 10, that it be coupled to some other safety device.

As seen in FIG. 1, battery controller 10 is connected between terminals 16 of battery 12 and corresponding terminals 18 for connection to appliance 14. Controller 10 has an additional connection to appliance 14, which is an I/O line 20 for communication of data between battery controller 10 and appliance 14. For convenience of packaging, it is preferred that controller 10 reside on battery 12, though controller 10 may reside apart if desired.

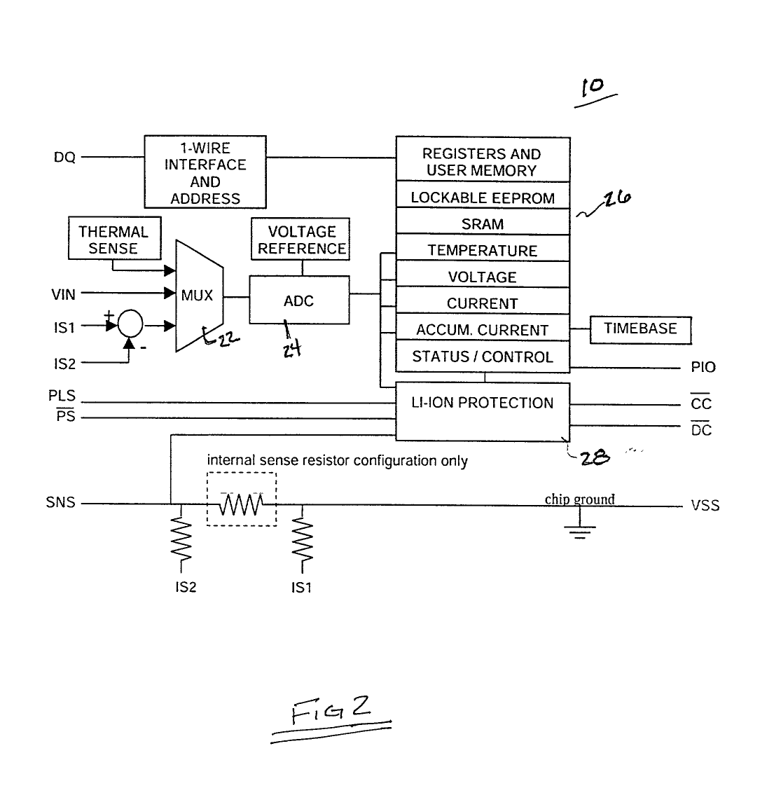

Referring to FIG. 2, a schematic of battery controller 10 is depicted. Each of the labeled inputs and outputs corresponds to a pin of controller 10, for example, in either a thin shrink small outline package (TSSOP) or flip-chip type package. Battery controller 10 has a data input-output line DQ for communication of data with appliance 14. It is preferred that communication between controller 10 and appliance 14 is performed using the Dallas Semiconductor, Inc. 1-wire communication protocol, described in detail in U.S. Pat. No. 5,398,326, and which is incorporated by reference in its entirety herein. The 1-wire protocol is also described in DS19XX, which is incorporated by reference in its entirety herein. One skilled in the art will readily appreciate that other communication protocols and methods, which might use a different communication medium other than the single I/O line, for example I²C or EIA-232D, can be employed. Each controller 10 has a unique identifying net address which can be read through line DQ. This unique net address is useful in that it allows differentiation between multiple controllers, and is used in addressing commands to controller 10 as described in more detail below.

In the preferred embodiment, battery controller 10 has a multiplexer 22 which receives several inputs and multiplexes these inputs into a single signal. One input can be, for example, from a temperature sensor 24 which can continually sense and/or measure the battery temperature, outputting a signal into multiplexer 22. Referring to both FIGS. 1 and 2, this multiplexer 22 also receives a voltage signal VIN from the positive terminal 16 of battery 12 which is referenced against the voltage of negative terminal 16 and used in monitoring the voltage between positive and negative terminals 16. Two current sense inputs IS1 and IS2 are used in sensing the current through terminals 16. The output of multiplexer 22 is channeled through an analog to digital converter 24 to be stored in registers 26 and used in a protection circuitry 28. The registers 26 and the operation of protection circuitry 28 are discussed in more detail below. At this point, however, note that protection circuitry 28 also receives inputs PLS to monitor the status of terminals 18, PS for power switching, and SNS for use also in current sensing. Each of these inputs is described in more detail below accompanying the functions to which they relate.

FIG. 3 is a register table depicting a preferred configuration of registers 26. The first column is a description of the register. The second column indicates whether the register is read-only or read-write, and the third column lists the variables stored in each respective register. Controller 10 has a lockable general register, organized into two blocks, block 0 and block 1. Registers having two bytes, with a most significant bit (MSB) and least significant bit (LSB), are configured such that when the MSB of any two byte register is read, the MSB and the LSB are latched and held for the duration of the read to prevent updates during the read. This also ensures synchronization between two bytes of a register.

The general register can be locked to ignore write commands, and function essentially as read-only. Registers 26 of battery controller 10 have a general administration register used in administration of the general register. This can be a one-byte register with a LOCK flag, a BL1 flag, and a BL0 flag.

BL1 and BL0 are read-only bits indicating that the general register is locked, and correspond to general register block 1 and block 0 respectively. A one in either bit indicates that the corresponding general register block is locked, while a zero indicates the block is unlocked. Thus, when BL1 contains a one, Block 1 is locked and when BL0 contains a one, block 0 is locked.

The LOCK bit is a read-writeable bit used in enabling or disabling the general register lock. When this bit is zero, the general register cannot be locked. Writing a one to this bit enables the general register to be locked. After the general register is locked, the lock bit is reset to zero.

Controller 10 can be instructed to lock a block of the general register if the LOCK bit, as discussed above, is set to 1. This is done by identifying the net address of the controller 10 to which the command is directed and identifying the address in registers 26 of the general register to lock. Once locked, the register cannot be written again. If the LOCK bit is 0, the lock command is ignored.

Registers 26 also ideally contain a temperature register to store output from temperature sensor 24. The temperature register is preferably in a two byte format and is read-only.

Registers 26 also ideally contain a protection register with flags for indicating the status of protection circuit 28 and switches which give conditional control over charging and discharging paths. Preferably, the protection register is a one byte allocation, and stores an over-voltage flag OV, under voltage flag UV, charge over current flag COC, discharge over current flag DOC, a charge enable bit CE, a discharge enable bit DE and two pin mirrors CC and DC. Over voltage flag OV is set to indicate that battery 12 has experienced an over voltage condition, such as when it has been over charged. Under voltage flag UV is set to indicate battery 12 has experienced an under voltage condition, such as when it has been over discharged. Charge over current flag COC is set to indicate battery 12 has experienced a charge-direction over current condition, such as excessive charge current. Discharge over current flag DOC is set to indicate battery 12 has experienced a discharge-direction over current condition, such as a short circuit. The charge enable bit CE is set to enable charging and the discharge enable bit DE is set to enable discharging. The operations of these bits are discussed in more detail below. The CC pin mirror and DC pin mirror are read-only bits which mirror the state of the CC output pin and DC output pin (FIG. 1). The over voltage flag OV, under voltage flag UV, charge over current flag COC and discharge over current flag DOC are set by protection circuitry 28 when the condition occurs.

As is described in more detail below, the registers 26 can be accessed through data input/output pin DQ. Thus, appliance 14 can read the values of the various registers to gain information about battery 12. For example, it is anticipated that appliance 14 would regularly read the OV, UV, COC, and DOC flags to find whether controller 10 had reported a potentially damaging condition. In the case of the read/write bits, appliance 14 can write into the bits to change the parameters in controller 10. In the case of the OV, UV, COC, and DOC flags, once they are set by controller 10, these bits must be reset by appliance 14.

Charging and discharging of battery 12 is controlled by the switching of a first field effect transistor (FET) 32 and a second field effect transistor (FET) 34 (FIG. 1) positioned in opposite polarity, so that when first FET 32 is off it prevents current flow into battery 12 (charging) and when second FET 34 is off it prevents current flow out of battery 12 (discharging). Pin CC is pulled high to switch first FET 32 off, and disable charging by stopping current flow into battery 12. Pin DC is pulled high to switch second FET 34 off, and disable discharging by stopping current flow out of battery 12. Bits CC and DC mirror these pins to indicate the status of FETs 32 and 34. Pins CC and DC are controlled by the charge enable bit CE and the charge disable bit DE. Writing a 0 to the CE bit pulls CC high and disables charging regardless of battery 12 conditions. Writing a 1 to the CE bit enables discharging, subject to an override by protection circuitry 28. Writing a 0 to the DE bit pulls DC high and disables discharging regardless of battery 12 conditions. Writing a 1 to the DE bit enables discharging subject to an override by protection circuitry 28. The default values of charge enable bit CE and discharge charge enable bit DE are stored in lockable general register. Recalling data from general register block 1 resets CE bit and DE bit to their default values. Thus, by changing the values of the CE and DE bits, appliance 14 has conditional control over the charging and discharging of a battery 12.

A status register stores bits that indicate the status of battery controller 10. The flags include PMOD used in power mode operations, RNAOP related to reading the net address of a controller 10, and SWEN used to enable and disable battery swapping in multiple battery 12 configurations. The these bits are discussed in more detail below accompanying the description of the functions to which they relate.

Registers 26 contain a voltage register. Battery controller 10 continually measures the voltage between pins VIN and VSS and the resulting data is placed in the voltage register.

Battery controller 10 continually measures the current flow into and out of battery 12 by measuring the voltage drop across a current sense resistor. FIG. 1 depicts batter controller 10 with an external current sense resistor 36 wired to a terminal 16 of the battery 12 to read the same as VSS. FIG. 1A depicts a detail view of battery controller 10 with an internal current sense resistor 36a. There is no external sense resistor 36 in this configuration. A further example of the use of the internal sense resistor can be found in U.S. Pat. No. 6,091,318, which is hereby incorporated by reference in its entirety. In either configuration, battery controller 10 measures the voltage difference between pins IS1 and IS2, and writes the result (V_{IS}) or a current calculated from the result (I_{SNS}) to a current register in registers 26. If V_{IS} is positive, this indicates current is flowing into battery 12, and that battery 12 is charging. If V_{IS} is negative, this indicates current is flowing out of battery 12, and that battery 12 is discharging. For an external sense resistor configuration (FIG. 1), battery controller 10 writes the measured V_{IS} voltage to a current register in registers 26 as a value representative of a voltage. For an internal sense resistor configuration (FIG. 1A), battery controller 10 writes a current (I_{SNS}) calculated from the known value of the sense resistor 36a into the current register. Battery controller 10 can automatically compensate for variations in the internal sense resistor 36a due to temperature when reporting the current.

A protection circuitry 28 monitors battery 12 voltage and current to protect battery 12 from over voltages, such as over charging, under voltages such as over discharge, and excessive charge and discharge currents such as short circuit or an over current condition. If a potentially damaging condition is detected, the protection circuitry 28 actuates either first FET 32 or second FET 34 to prevent the damage and reports the condition to set a corresponding flag (OV, UV, COC, or DOC) in the protection register.

If the voltage between terminals 16 of battery 12 exceeds an over voltage threshold V_{OV} for a period longer than over voltage delay T_{OVD}, battery controller 10 pulls CC high to shut off first FET 32 and sets the OV flag in the protection register. This prevents battery 12 from further charging and prevents damage from the over voltage. When the voltage between terminals 16 of battery 12 falls below a charge enabled threshold V_{CE}, battery controller 10 turns first FET 32 back on, and again allows battery 12 to charge. It is important to note that second FET 34 is unchanged in an over voltage condition, and battery 12 can continue to discharge or provide power to appliance 14.

If the voltage of battery 12 drops below under voltage threshold V_{UV} for a period longer than under voltage delay T_{UVD}, battery controller 10 pulls CC and DC high shutting off both first FET 32 and second FET 34, so that battery 12 can neither charge or discharge. Protection circuitry 28 also sets the UV flag in the protection register, and battery controller 10 enters a sleep mode. This requires that controller 10 be reset to receive a charge, and prevents a possible over voltage while controller 10 is not monitoring battery 12.

Battery controller 10 has an active mode and a sleep mode. In active mode, controller 10 monitors battery 12 as described herein. In a sleep mode, however, battery controller 10 can cease activity, and for example can be configured so that it does not measure current, voltage, or temperature. Though, data stored in registers 26 are still available to appliance 14. Sleep mode is utilized when the monitoring capabilities are not required, such as when the battery 12 is disconnected from appliance 14. This conserves power, because no current is drawn from battery 12 to perform the monitoring functions.

Controller 10 in a preferred embodiment, can be made to enter sleep mode, thereby disconnecting battery 12 from appliance 14, if the data input output line DQ goes low for more than a given time, preferably 2 seconds, when the PMOD bit in the status register is 1. Also, when PMOD bit is 1, controller 10 will revert to active mode when the DQ line goes high. The PMOD bit is a read-only bit, and its desired default value is set in the general register.

As discussed above, controller 10 measures the voltage difference between IS1 and IS2, and the result is V_{IS}. This voltage (V_{IS}) is the voltage drop across the current sense resistor 36 or 36a. In an external current sense resistor configuration (FIG. 1), V_{IS} is compared to an over current threshold voltage V_{OC}. If V_{IS} exceeds V_{OC} for a period longer than an over current delay T_{OCD}, the battery controller 10 shuts off both first and second FET 32, 34 to prevent all flow to and from battery 12. Battery controller 10 also sets COS flag in the protection register. In the case of an internal sense resistor configuration (FIG. 1A), the over current threshold is expressed in terms of a current I_{OC} and is compared against I_{SNS}. If I_{SNS} is greater than I_{OC} for a period longer than over current delay T_{OCD}, the battery controller shuts off both first and second FETs 32, 34 and sets the COC flag in the protection register. In either case, the FETs 32 and 34 are not turned back on until the voltage at positive terminal 16 measured at pin PLS drops below a given threshold, preferably VDD minus a test voltage V_{TP}. Battery controller 10 provides a test current of value I_{TST} from the PLS pin to the VSS pin to pull the PLS pin down when the offending charge current source has been removed. This situation represents an over current in the charge-direction. V_{OC}, I_{OC}, and T_{OCD} are values chosen based on specific characteristics of battery 12 to prevent damage.

Battery controller 10 senses an over current in the discharge-direction in an external sense resistor configuration (FIG. 1) when V_{IS} is less than a negative of V_{OC} for a time period longer than T_{OCD}, and in an internal sense resistor configuration (FIG. 1A) when I_{SNS} is less than a negative of I_{OC} for a time period longer than T_{OCD}. In this situation, battery controller 10 pulls DC high to shut off second FET 34. Battery controller 10 sets the DOC flag and the protection register. The discharge path is not reestablished until the voltage on the PLS pin rises above a given threshold, preferably VDD minus V_{TP}. Battery controller 10 provides a test current of value I_{TST} from VDD to PLS pin to pull PLS pin up when the offending low impedance load has been removed.

Battery controller 10 senses a short circuit when the voltage on the SNS pin with respect to the VSS pin (V_{SNS}) exceeds a short circuit threshold V_{SC} for a period longer than short circuit delay T_{SCD}. In this situation, battery controller 10 pulls DC high to shut off second FET 34 and sets the DOC flag in the protection register. The discharge current path is not reestablished until the voltage on PLS pin rises above a given threshold, preferably VDD minus V_{TP}. Battery controller 10 provides a test current of value I_{TST} from VDD to PLS pin to pull PLS pin up when the short circuit has been removed. V_{SC} and T_{OCD} are values chosen based on specific characteristics of battery 12 to prevent damage.

Battery controller 10 further can track the net current flow into and out of battery 12 for purposes of capacity estimation. This is done in a current accumulator. Current flowing into the battery increments the current accumulator up, while current flowing out of the battery increments the current accumulator down. Thus, the current accumulator tracks the net current flow into and out of 12 over time. This is useful for gauging how much charge is available in 12. When an internal sense resistor is used, the current accumulator can be or is generally maintained in units representative of amp hours. When an external sense resistor is used, the current accumulator can be or is generally maintained in units representative of volt hours. Just as the current measurement is compensated for by temperature, the current accumulation can also be compensated for temperature.

Battery controller 10 has a user definable current offset bias used to compensate for sources of current offset other than temperature. The bias value is preferably stored in the general register, and subtracted from current measurements. In the case of an external sense resistor (FIG. 1) the value can be stored in a form representative of a voltage, and in an internal sense resistor (FIG. 1A) the value can be stored in a form representative of a current.

Registers 26 of battery controller 10 can also have a special feature register. In this register, there are a PS, PIO and MSTR bit. The PS bit mirrors the state of the PS pin, and is read-only. Thus, if the PS pin is high, the PS bit also reads high. If the PS pin is low, the PS bit reads low. The PS bit and PS pin are described in more detail below.

The PIO bit in the special feature register is used for controlling and monitoring user-defined external circuitry. By rewriting the desired output value in the PIO bit, a user can control the PIO pin of battery controller 10. For example, writing a zero to the PIO bit enables the PIO output driver, thus pulling the PIO pin to the voltage of VSS. Writing a one to the PIO bit disables the output driver allowing the PIO pin to be pulled high or used as an input. To sense the value of the PIO pin, one need only read the PIO bit. Battery controller 10 turns off the PIO output driver when it enters sleep mode or when DQ is low for more than a given time, preferably two seconds, regardless of the state of the PMOD bit.

The MSTR bit is a swap master status bit used when accessing multiple battery 12. The MSTR bit is discussed in more detail below in connection with the functions to which it relates.

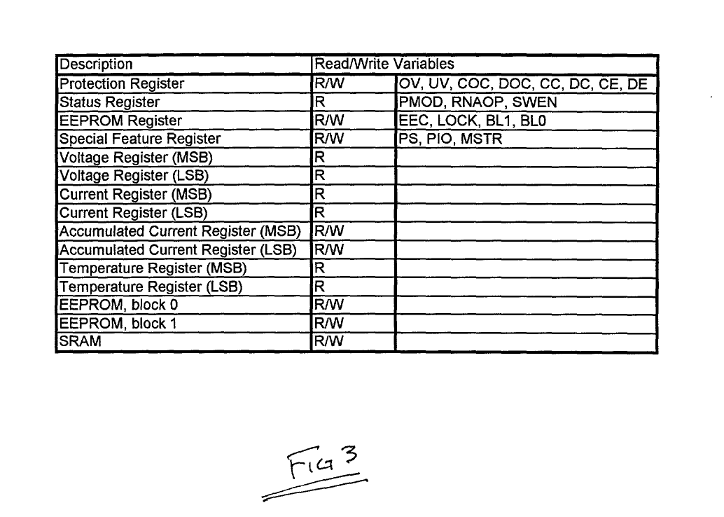

The PS pin of battery controller 10 is a power switch input, which modulates second FET 34 to gate power from battery 12. Referring to FIG. 4, the PS pin is internally pulled to VDD through a current source 38, and is continuously monitored for a low impedance connection to VSS with a pnp-type transistor 40. Transistor 40 turns on when its base, the PS pin, drops below a threshold voltage. Turning transistor 40 on opens the second FET 34. If the battery controller 10 is in sleep mode, the detection of a low on PS causes the device to transition into active mode. The transition into active mode turns on second FET 34 enabling battery 12 to discharge. If battery controller is already in active mode, activity on PS has no effect other than the mirroring of its logic level in the PS bit in the special feature register. One skilled in the art will appreciate that the PS pin could modulate the first FET 32 to switch charging of battery 12, or both the first and second FETs 32 and 34 depending on the desired result.

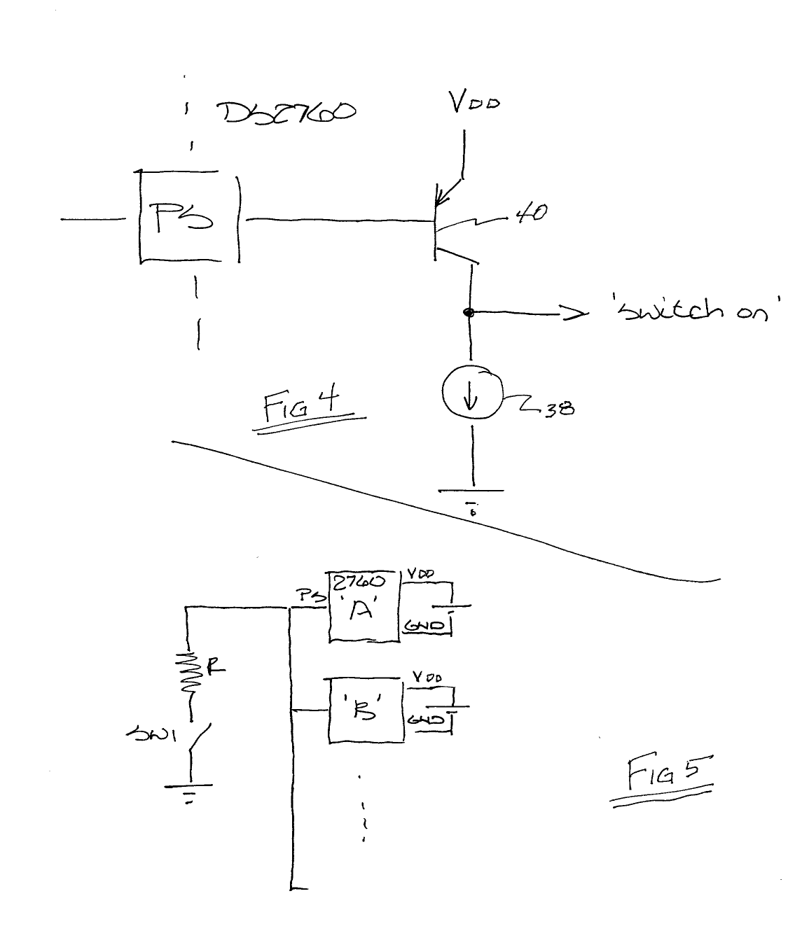

An appliance 14 utilizing multiple battery 12 can be configured such that battery 12 selection, to some degree, is automatic. By linking multiple batteries 12 with their PS pins in parallel, as shown in FIG. 5, the battery 12 having the highest voltage is automatically set to discharge. This happens because the PS pin of each controller 10 actuates the second FET 34 to enable discharging when it senses a connection to a voltage below the threshold of its transistor 40. As the PS pin is internally drawn to VDD, the voltage at PS pin is equal to VDD minus a threshold voltage of the transistor 40. When the PS pins of multiple controllers 10 with different voltages, representing battery 12 of different voltages, are connected in parallel on the same line, only the PS pin with the highest voltage will sense a lower voltage. A voltage below the threshold will trigger only this PS pin and its controller 10 will enable its corresponding battery 12 to discharge. The PS pins of the remaining controllers 10 do not sense a lower voltage and are thus not actuated to discharge. This feature of battery controller 10 allows for simplified battery 12 selection.

Battery controller 10 responds to commands over the one-wire network through the DQ pin. Multiple battery 12 each having a battery controller 10 can be linked in parallel off of I/O line 20 to appliance 14, as shown in FIG. 6. In general, communication is initiated with a reset pulse transmitted by a bus master, and each bus slave responds with a presence pulse indicating to the bus master that there are one or more devices on the bus ready to operate. If there is only one slave on the bus, the master can read its net address or specify to the slave that it will not use net addresses when sending commands. If there is more than one slave on the bus, the master can determine the net address of each slave by reading the net address bit by bit. Once it has determined the net address of a particular slave, or if it already knows the net address of a slave, it can specify that all commands given until the next reset pulse are intended for a particular slave.

Appliance 14, acting as master, can read data from registers 26 of a controller 10, acting as a slave. Once it is established which controller 10 is to act on the command, as described above, appliance 14 can send an operation code representing a read command and identify the address in the registers 26 at which controller 10 wishes to begin reading. The operation code representing the read command can be changeable between at least two operation commands in a particular controller 10, for example a primary and an alternate operation code. Setting the RNAOP bit in the status register to 1, tells a controller 10 to interpret the primary operation code as the read command, and setting the RNAOP bit to 0 tells a controller 10 to interpret the alternate operation code as the read command.

Data can be written to registers 26 of a controller 10 by sending the operation code representing a write command and identifying the location in the registers 26 to begin writing. Writes to read-only and reserved addresses and locked general register blocks are ignored. As mentioned above, writes to unlocked general register blocks are written to SRAM rather than general register. The data in SRAM is then copied to general register when controller 10 receives instructions, in the form of an operation code, to copy. Data can also be recalled from the general register to SRAM in the same manner with a operations code representing a recall command.

Finally, controller 10 responds to a operation code representing a swap command, used in managing multiple battery 12. The swap command, followed by a net address, can be sent across the one-wire network. A particular battery controller 10 with the corresponding net address reads the swap command, recognizes its net address, and sets the MSTR bit in the special feature register. The MSTR bit indicates that the particular controller 10 is the selected device, and that other controllers 10 on the I/O line 20 are deselected. Upon receiving the swap command, the selected battery controller 10 enables power to or from appliance 14 while deselecting and powering down all the other controllers 10, which each switch second FET 34 off to prevent discharge and enter sleep mode. It is important to note that battery controller 10 powers down the unselected batteries before powering up. This switching sequence is controlled by a timing pulse issued on the DQ line following the net address. The leading the edge of the pulse is used to disable power in the unselected batteries 12 and the trailing edge of the pulse is used to enable power in addressed battery controller 10. A battery controller 10 will recognize the swap command, net address and timing pulse if and only if the SWEN bit in the status register is set to one.

Use of the swap command allows a convenient method of selecting a particular battery 12 in a multiple battery 12 configuration with a single command regardless of how many batteries 12 are utilized. Appliance 14 need only issue the swap command and the net address of the particular battery 12 from which it is desired that it draw power, the selected battery 12 powers up, and then powers down all other batteries 12 in the system without having to address each individually.

In addition to use of the swap command, appliance 14 has conditional control over each particular battery 12 through its controller 10. As discussed above, appliance 14 can write to the CE and DE bits to enable charging and discharging, subject to override, and disable charging and discharging. By using its unique net address, appliance 14 can direct its control to a particular battery 12 in a multiple battery 12 configuration. Thus, this allows appliance 14 broad control in both systems with a single battery 12 and multiple battery 12 configurations.

Although the present invention is described with relation to the illustrated embodiments, those skilled in the art can readily recognize that numerous variations, substitutions or deletions may be made from the embodiments shown and described, however the invention use and its configuration would achieve substantially the same or similar results as achieved by the specific exemplary embodiments described herein. For instance, although the preferred embodiment has been described using the Dallas Semiconductor, Inc. 1-wire protocol with the DQ pin, it would be clear to one of ordinary skill in the art that other communication protocols, both from a hardware and software standpoint can be used. Systems such as I²C, EIA-232D, or other systems will work quite well. Accordingly, there is no intention to limit the invention to the disclosed exemplary form. Many variations, modifications and alternative constructions fall within the scope and spirit of the disclosed invention as expressed in the claims.

We claim:

1. A device for actuating a switch coupled to a terminal of a power supply, comprising:
a monitor circuit adapted to be coupled to the power supply for monitoring at least one parameter of the power supply and actuating the switch to cease current flow if a value representative of the at least one monitored parameter exceeds a given value; and
a controller circuit for actuating the switch to cease current flow responsive to a received signal regardless of the at least one monitored parameter.

2. The device of claim 1 wherein the controller circuit acts responsively to a second signal and actuates the switch allow current flow subject to override by the monitor.

3. The device of claim 2 wherein the second signal is connecting the controller to a voltage lower than a voltage of the power supply.

4. The device of claim 1 wherein the power supply is rechargeable.

5. The device of claim 1 wherein the monitor circuit comprises a current monitor for measuring current flow from the power supply.

6. The device of claim 1 further comprising a current accumulator coupled to the monitor circuit for accumulating values representative of the amount of current having flowed out of the power supply.

7. The device of claim 1 further comprising a current accumulator coupled to the monitor circuit for accumulating values representative of the net amount of current having flowed into and out of the power supply.

8. The device of claim 1 wherein the monitor circuit comprises a voltage monitor for measuring the voltage of the power supply.

9. The device of claim 1 further comprising:
a data line for communication with the device; and
a register coupled to the monitor circuit, wherein at least one value representative of the at least one monitored parameter is stored in the register and accessible through the data line.

10. The device of claim 9 wherein the controller circuit receives the signal through the data line and actuates the switch.

11. The device of claim 1 wherein the device is a first device, further comprising:
a data line for communication with the first device; and
wherein the first device sends a signal over the data line to a second device, the signal for instructing the second device to actuate a second switch coupled to a terminal of a second power supply.

12. The device of claim 1 used with a portable electronic device.

13. The device of claim 1 wherein the monitor circuit actuates the switch to cease current flow if a value representative of the at least one monitored parameter is below a second given value.

14. The device of claim 1 further comprising a temperature monitor for monitoring the temperature of the power supply.

15. A system for controlling power flow between a first and second power supply and an appliance, comprising:
a first switch coupled to the first power supply for switching power flow between the first power supply and the appliance;
a second switch coupled to the second power supply for switching power flow between the second power supply and the appliance;
a first controller circuit coupled to the appliance, the first switch, and the first power supply for monitoring at least one parameter of the first power supply and actuating the first switch to cease power flow if a value representative of the at least one monitored parameter exceeds a given value;
a second controller circuit coupled to the appliance, the second switch, and the second power supply for monitoring at least one parameter of the second power supply and actuating the second switch to cease power flow if a value representative of the at least one monitored parameter exceeds a given value; and
wherein upon receiving a signal the first controller circuit provides a signal to the second controller circuit, wherein the second controller circuit actuates the second switch to allow power flow between the second power supply and the appliance and the first controller circuit actuates the first switch to cease power flow between the first power supply and the appliance.

16. The system of claim 15 wherein upon receiving a second signal, the first controller circuit actuates the first switch to cease power flow between the power supply and the appliance without signaling the second controller circuit.

17. The system of claim 15 wherein upon receiving a second signal, the first controller circuit actuates the first switch to allow power flow between the power supply and the appliance without signaling the second controller circuit.

18. The system of claim 15 wherein the first controller circuit comprises a current monitor for measuring current flow from the first power supply.

19. The system of claim 15 further comprising a current accumulator for accumulating values representative of the amount of current having flowed out of the first power supply.

20. The system of claim 15 further comprising a current accumulator for accumulating values representative of the net amount of current having flowed into and out of the first power supply.

21. The system of claim 15 wherein the first controller circuit comprises a voltage monitor for monitoring a voltage of the first power supply.

22. The system of claim 15 further comprising a register for storing at least one value representative of the at least one monitored parameter.

23. The system of claim 15 used in a portable electronic device.

24. The system of claim 15 wherein the first power supply is rechargeable.

25. The device of claim 15 wherein the first controller circuit actuates the first switch to cease power flow if a value representative of the at least one monitored parameter is below a second given value.

26. The device of claim 15 wherein the second controller circuit actuates the second switch to cease power flow if a value representative of the at least one monitored parameter is below a second given value.

27. The device of claim 15 wherein the first controller further comprises a temperature monitor for monitoring a temperature of the power supply.

28. A system for controlling power flow between a first and second power supplies and an appliance, comprising:
a first switch coupled to the first power supply for switching power flow between the first power supply and the appliance;
a second switch coupled to the second power supply for switching power flow between the second power supply and the appliance;
a first controller circuit coupled to the first switch and the first power supply for monitoring at least one parameter of the first power supply and actuating the first switch to cease power flow if a value representative of the at least one monitored parameter exceeds a given value;
a second controller circuit coupled to the first controller circuit, the second switch, and the second power supply for monitoring at least one parameter of the second power supply and actuating the second switch to cease power flow if a value representative of the at least one monitored parameter exceeds a given value; and
wherein the second controller circuit senses a voltage of the first power supply through the first controller circuit, senses a voltage of the second power supply, and actuates the second switch to allow power flow between the second power supply and the appliance if the voltage of the second power supply is greater than the voltage of the first power supply.

29. The system of claim 28 wherein the first controller circuit senses a voltage of the second power supply through the second controller circuit, senses a voltage of the first power supply, and actuates the first switch to cease power flow between the first power supply and the appliance if the voltage of the second power supply is greater than the voltage of the first power supply.

30. The system of claim 28 wherein the first controller circuit senses a voltage of the second power supply through the second controller circuit, senses a voltage of the first power supply, and actuates the first switch to allow power flow between the first power supply and the appliance if the voltage of the first power supply is greater than the voltage of the second power supply.

31. The system of claim 28 wherein the first controller circuit comprises a current monitor for measuring current flow from the first power supply.

32. The system of claim 28 wherein the first controller circuit further comprises a current accumulator for accumulating values representative of the amount of current having flowed out of the first power supply.

33. The system of claim 28 wherein the first controller circuit further comprises a current accumulator for accumulating values representative of the net amount of current having flowed into and out of the first power supply.

34. The system of claim 28 wherein the first controller circuit comprises a voltage monitor for monitoring a voltage of the first power supply.

35. The system of claim 28 wherein the controller circuit further comprises a register for storing at least one value representative of the at least one monitored parameter.

36. The system of claim 28 used in a portable electronic device.

37. The system of claim 28 wherein the first power supply is rechargeable.

38. The device of claim 28 wherein the first controller circuit actuates the first switch to cease power flow if a value representative of the at least one monitored parameter is below a second given value.

39. The device of claim 28 wherein the first controller circuit actuates the first switch to cease power flow if a value representative of the at least one monitored parameter is below a second given value.

40. The device of claim 28 wherein the first controller further comprises a temperature monitor for monitoring a temperature of the first power supply.

41. A system for controlling power flow between a first and second power supplies and an appliance, comprising:
a first switch coupled to the first power supply for switching power flow between the first power supply and the appliance;
a second switch coupled to the second power supply for switching power flow between the second power supply and the appliance;
a first controller circuit coupled to the first switch for actuating the first switch;
a second controller circuit coupled to the first controller circuit and the second switch for actuating the second switch; and
wherein upon receiving a signal the first controller circuit signals the second controller circuit to actuate the second switch to allow power flow between the second power supply and the appliance, and actuates the first switch to cease power flow between the first power supply and the appliance.

42. The system of claim 41 wherein upon receiving a second signal from the appliance, the first controller circuit actuates the first switch to cease power flow between the power supply and the appliance without signaling the second controller circuit.

43. The system of claim 41 wherein upon receiving a second signal from the appliance, the first controller circuit actuates the first switch to allow power flow between the power supply and the appliance without signaling the second controller circuit.

44. The system of claim 41 wherein the first controller circuit comprises a current monitor for measuring current flow from the first power supply.

45. The system of claim 41 further comprising a current accumulator for accumulating values representative of the amount of current having flowed out of the first power supply.

46. The system of claim 41 further comprising a current accumulator for accumulating values representative of the amount of current having flowed out of the first power supply.

47. The system of claim 41 wherein the first controller circuit comprises a voltage monitor for monitoring a voltage of the first power supply.

48. The system of claim 41 further comprising a register for storing at least one value representative of the at least one monitored parameter.

49. The system of claim 41 used in a portable electronic device.

50. The system of claim 41 wherein the first power source is rechargeable.

51. The system of claim 41 wherein the first controller circuit comprises a temperature monitor for monitoring a temperature of the first power supply.

52. A method of switching power flow between a power supply and an appliance, comprising the steps of:
providing a switch coupled between the power supply and the appliance;
monitoring at least one parameter of the power supply and actuating the switch to cease current flow between the power supply and appliance if a value representative of the at least one monitored parameter exceeds a given value; and
monitoring the appliance for a signal to actuate the switch and actuating the switch to cease current flow between the power supply and appliance upon receipt of the signal.

53. The method of claim 52 further comprising the step of monitoring the appliance for a second signal to actuate the switch, and actuating the switch to allow current flow between the power supply and appliance upon receipt of the signal.

54. The method of claim 52 wherein the step of monitoring at least one parameter of the power supply comprises monitoring the current flow from the power supply.

55. The method of claim 52 further comprising the step of accumulating values representative of the amount of current having flowed out of the power supply.

56. The method of claim 52 further comprising the step of accumulating values representative of the net amount of current having flowed into and out of the power supply.

57. The method of claim 52 wherein the step of monitoring at least one parameter of the power supply comprises monitoring a voltage of the power supply.

58. The method of claim 52 further comprising the step of storing at least one value representative of the at least one monitored parameter so as to be accessible to the apparatus.

59. The method of claim 52 wherein the step of monitoring at least one parameter of the power supply, further comprises actuating the switch to cease current flow between the power supply and appliance if a value representative of the at least one monitored parameter is below a second given value.

60. The method of claim 52 further comprising the step of monitoring a temperature of the power supply.

61. A method of switching power flow between a first and second power supplies and an appliance, comprising the steps of:
providing a first switch coupled between the first power supply and the appliance;
providing a second switch coupled between the second power supply and the appliance;
monitoring at least one parameter of the first power supply and actuating the first switch to cease current flow between the first power supply and the appliance if a value representative of the at least one monitored parameter exceeds a given value; and
monitoring the appliance for a signal and upon receiving the signal actuating the second switch to allow power flow between the second power supply and the appliance and actuating the first switch to cease power flow between the power supply and appliance.

62. The method of claim 61 further comprising the step of monitoring the appliance for a second signal and upon receiving the second signal actuating the first switch to allow power flow between the power supply and appliance.

63. The method of claim 61 wherein the step of monitoring at least one parameter of the first power supply comprises monitoring the current flow from the first power supply.

64. The method of claim 61 further comprising the step of accumulating values representative of the amount of current having flowed out of the first power supply.

65. The method of claim 61 further comprising the step of accumulating values representative of the net amount of current having flowed into and out of the first power supply.

66. The method of claim 61 wherein the step of monitoring at least one parameter of the first power supply comprises monitoring a voltage of the power supply.

67. The method of claim 61 further comprising the step of storing at least one value representative of the at least one monitored parameter so as to be accessible to the appliance.

68. The method of claim 61 wherein the step of monitoring at least one parameter of the first power supply further comprises actuating the first switch to cease current flow between the first power supply and the appliance if a value representative of the at least one monitored parameter is below a second given value.

69. The method of claim 61 wherein the step of monitoring at least one parameter of the second power supply further comprises actuating the second switch to cease current flow between the second power supply and the appliance if a value representative of the at least one monitored parameter is below a second given value.

70. The method of claim 61 further comprising the step of monitoring the temperature of the first power supply.

71. A charging control circuit for controlling charging of a rechargeable power supply and for actuating a switch in response to a signal, comprising:
a monitor circuit adapted to be coupled to the rechargeable power supply and adapted to be coupled to the switch, for monitoring at least one parameter of the power supply and actuating the switch to cease current flow if a value representative of the at least one monitored parameter exceeds a given value; and
a switch controlling circuit adapted to be coupled to the switch for actuating the switch to cease current flow responsive to a received signal regardless of the at least one monitored parameter.

72. The control circuit of claim 71 wherein the switch controlling circuit acts responsively to a second signal and actuates the switch to allow current flow subject to override by the monitor.

73. The control circuit of claim 71 wherein the monitor circuit comprises a current monitor for measuring current flow into the power supply.

74. The control circuit of claim 71 further comprising a current accumulator coupled to the monitor circuit for accumulating values representative of the amount of current having flowed into the power supply.

75. The control circuit of claim 71 wherein the monitor circuit comprises a voltage monitor for measuring the voltage of the power supply.

76. The control circuit of claim 71 further comprising:
a data line for communication with the control circuit; and
a register coupled to the monitor circuit, wherein at least one value representative of the at least one monitored parameter is stored in the register and accessible through the data line.

77. The control circuit of claim 76 wherein the switch controlling circuit receives the signal on the data line.

78. The control circuit of claim 71 wherein the control circuit is a first control circuit, further comprising:
a data line for communication with the first control circuit; and
wherein the first control circuit sends a signal over the data line to a second control circuit, the signal for instructing the second control circuit to actuate a second switch coupled to a terminal of a second power supply.

79. The control circuit of claim 71 used with a portable electronic device.

80. The control circuit of claim 71 used as a discharging control circuit.

81. The control circuit of claim 71 wherein the monitor circuit actuates the switch to cease current flow if a value representative of the at least one monitored parameter is below a second given value.

82. The control circuit of claim 71 further comprising a temperature monitor for monitoring a temperature of the power supply.
